(19) United States
(12) Patent Application Publication
(10) Pub. No.: US 2025/0218095 A1
(43) Pub. Date: Jul. 3, 2025

(54) METHOD AND RELATED DEVICE FOR INTERACTING BASED ON VIRTUAL OBJECT

(71) Applicant: Beijing Youzhuju Network Technology Co., Ltd., Beijing (CN)

(72) Inventors: Haoran LI, Beijing (CN); Weinan LIU, Beijing (CN); Junlin CAI, Beijing (CN); Jinhui GUO, Beijing (CN); Shengyan SHI, Beijing (CN); Hao YANG, Beijing (CN); Changfeng ZHAO, Beijing (CN); Yunpeng LIANG, Beijing (CN)

(21) Appl. No.: 19/007,163

(22) Filed: Dec. 31, 2024

(30) Foreign Application Priority Data
Jan. 3, 2024 (CN) 202410014932.5

(51) Int. Cl. G06T 13/40; G06F 3/04815; G06F 3/04817; G06T 17/00

(52) U.S. Cl. CPC G06T 13/40; G06F 3/04815; G06F 3/04817; G06T 17/00

(57) ABSTRACT

The disclosure provides a method and a related device for interacting based on a virtual object. The method includes: displaying a first page for presenting target content, where the first page includes a first control, and the first control includes an icon of the virtual object; playing a first animation corresponding to the virtual object in response to a trigger instruction for the first control; and displaying a second page related to the target content in response to the completion of playing of the animation. By playing the animation on the first page, the content displayed on the first page is diversified, thereby increasing the interest of the interaction.

### CROSS-REFERENCE

The present application claims priority to Chinese Patent Application No. 202410014932.5, filed on Jan. 3, 2024 and entitled “METHOD AND RELATED DEVICE FOR INTERACTING BASED ON VIRTUAL OBJECT”, the entirety of which is incorporated herein by reference.

### FIELD

The present disclosure relates to the field of computer technologies, and in particular, to a method and a related device for interacting based on a virtual object.

### BACKGROUND

Information delivery is a process of sending information to a terminal device. In Internet technologies, information delivery is usually a targeted delivery. For example, a target audience of the information is determined, and the information is sent to the target audience, so as to obtain better feedback.

In the related art, the styles of information delivery are relatively simple, the differences are not significant, and the interest is poor, so that the attention of users cannot be attracted.

### SUMMARY

In view of the above, an objective of the present disclosure is to provide a method and a related device for interacting based on a virtual object, to solve or partially solve the above problems.

Based on the above objective, a first aspect of the present disclosure provides a method for interacting based on a virtual object, comprising:
displaying a first page for presenting target content, wherein the first page comprises a first control, and the first control comprises an icon of the virtual object;
playing a first animation corresponding to the virtual object in response to a trigger instruction for the first control; and
displaying a second page related to the target content in response to the completion of playing of the first animation.

A second aspect of the present disclosure provides an apparatus for interacting based on a virtual object, comprising:
a first display module configured to display a first page for presenting target content, wherein the first page comprises a first control, and the first control comprises an icon of the virtual object;
a playing module configured to play a first animation corresponding to the virtual object in response to a trigger instruction for the first control; and
a second display module configured to display a second page related to the target content in response to the completion of playing of the first animation.

A third aspect of the present disclosure provides an electronic device, comprising a memory, a processor, and a computer program stored in the memory and executable on the processor, wherein the processor, when executing the program, implements the method according to the first aspect.

A fourth aspect of the present disclosure provides a non-transitory computer-readable storage medium storing computer instructions, wherein the computer instructions are configured to cause a computer to perform the method according to the first aspect.

A fifth aspect of the present disclosure provides a computer program product, comprising computer program instructions that, when running on a computer, cause the computer to perform the method according to the first aspect.

It can be seen from the above that the present disclosure provides a method and a related device for interacting based on a virtual object. The method includes: displaying a first page for presenting target content, wherein the first page includes a first control, and the first control includes an icon of the virtual object; playing a first animation corresponding to the virtual object in response to a trigger instruction for the first control; and displaying a second page related to the target content in response to the completion of playing of the animation. By playing the animation on the first page, the content displayed on the first page is diversified, thereby increasing the interest of the interaction.

### BRIEF DESCRIPTION OF THE DRAWINGS

In order to more clearly describe the technical solutions in the present disclosure or the related art, the following briefly describes the accompanying drawings for describing the embodiments or the related art. It is apparent that the accompanying drawings in the following description merely show some embodiments of the present disclosure, and a person of ordinary skill in the art may derive other drawings from these accompanying drawings without creative efforts.

FIG. 1A is a schematic diagram of an example system according to an embodiment of the present disclosure.

FIG. 1B is a schematic diagram of an example scenario according to an embodiment of the present disclosure.

FIG. 2A is a schematic diagram of an example page according to an embodiment of the present disclosure.

FIG. 2B is a schematic diagram of another example page according to an embodiment of the present disclosure.

FIG. 2C is a schematic diagram of another example page according to an embodiment of the present disclosure.

FIG. 2D is a schematic diagram of another example page according to an embodiment of the present disclosure.

FIG. 2E is a schematic diagram of another example page according to an embodiment of the present disclosure.

FIG. 2F is a schematic diagram of another example page according to an embodiment of the present disclosure.

FIG. 2G is a schematic diagram of another example page according to an embodiment of the present disclosure.

FIG. 2H is a schematic diagram of an example page according to an embodiment of the present disclosure.

FIG. 2I is a schematic diagram of another example page according to an embodiment of the present disclosure.

FIG. 3 is a schematic flowchart of an example method for interacting based on a virtual object according to an embodiment of the present disclosure.

FIG. 4 is a schematic diagram of an example apparatus for interacting based on a virtual object according to an embodiment of the present disclosure.

FIG. 5 is a schematic diagram of an example electronic device according to an embodiment of the present disclosure.

### DETAILED DESCRIPTION

In order to make the objectives, technical solutions, and advantages of the present disclosure clearer, the present disclosure is further described in detail below with reference to specific embodiments and the accompanying drawings.

It should be noted that the technical terms or scientific terms used in the embodiments of the present disclosure should have the general meaning understood by those of ordinary skill in the art to which the present disclosure belongs, unless otherwise defined. The terms “first”, “second” and similar words used in the embodiments of the present disclosure do not indicate any order, quantity or importance, but are merely used to distinguish different components. The words such as “comprise” or “include” mean that the elements or objects appearing before the word cover the elements or objects listed after the word and their equivalents, without excluding other elements or objects. The terms such as “connect with” or “connect to” are not limited to physical or mechanical connections, but may include electrical connections, whether direct or indirect. “Upper”, “lower”, “left”, “right” and the like are only used to indicate the relative position relationship, and when the absolute position of the described object changes, the relative position relationship may also change accordingly.

It may be understood that before the technical solutions of the embodiments of the present disclosure are used, the types, usage scopes, and usage scenarios of the involved personal information are notified to the users in an appropriate manner, and the users' authorization is obtained.

For example, when receiving an active request from the user, the prompt information is sent to the user to explicitly prompt the user that the requested operation will need to obtain and use the user's personal information. Therefore, the user can independently choose whether to provide personal information to the software or hardware, such as the electronic device, the application, the server, or the storage medium, that performs the operation of the technical solution of the present disclosure according to the prompt information.

As an optional but non-limiting implementation, in response to receiving an active request from a user, the prompt information may be sent to the user, for example, in a pop-up window, and the prompt information may be presented in the pop-up window in text. In addition, the pop-up window may also contain a selection control for the user to select “Agree” or “Disagree” to provide personal information to the electronic device. It may be understood that the above notification and user authorization process is only illustrative and does not limit the implementation of the present disclosure. Other methods that meet relevant laws and regulations may also be applied to the implementation of the present disclosure.

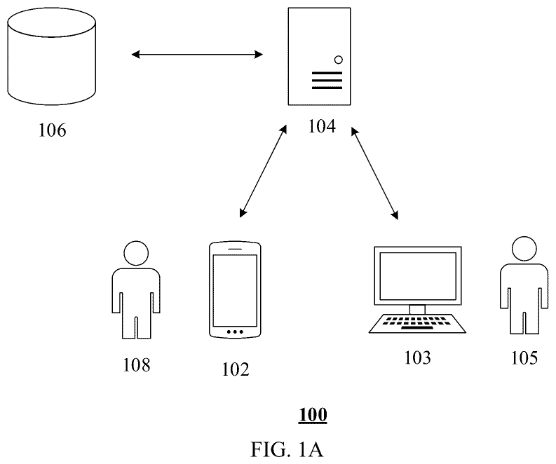

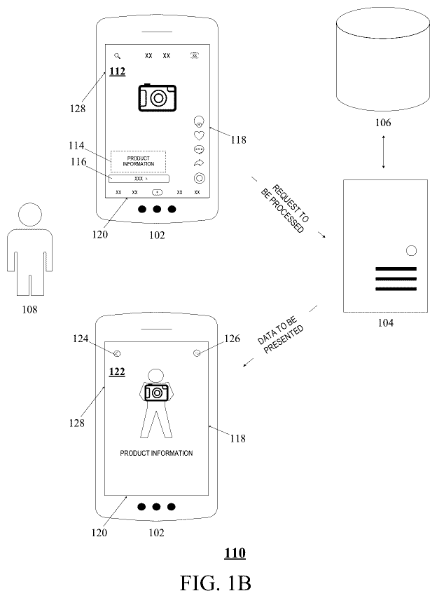

FIG. 1A shows a schematic diagram of an example system 100 according to an embodiment of the present disclosure. The system 100 may be a system for implementing the method for interacting based on a virtual object.

As shown in FIG. 1A, taking an example in which the terminal device and the server jointly execute the method for interacting based on a virtual object, the system 100 may comprise a terminal device 102, a computer device 103, a server 104, and a database 106. The terminal device 102 and the computer device 103 may be connected to the server 104 and the database 106 through a network, for example, through a wired or wireless network. The apparatus for implementing the method for interacting based on a virtual object may be integrated in the terminal device 102. The database 106 is connected to the server 104 through a network, for example, through a wired or wireless network. The database 106 may store data for processing an interaction request based on a virtual object and the like.

In the field of information delivery, the user 105 needs to contact the terminal device user 108 through information delivery or social media operation (for example, advertising) in order to establish a brand image and positioning or to promote the terminal device user 108 to purchase a product.

In an example scenario, the user 105 may use the system 100 to implement information delivery. As an example scenario, the user 105 may send an information delivery request to the server 104. The server 104 determines a delivery policy based on the information delivery request and feeds the delivery policy back to the user 105, for example, presents the delivery policy through the computer device 103. Then, the user 105 may use the computer device 103 to upload the final delivery policy to the server 104, so that the server 104 completes subsequent information delivery according to the final delivery policy. For example, information delivered according to the final delivery policy may be obtained and presented by the terminal device 102 of the terminal device user 108.

Various applications (referred to as APPs for short) may be installed on the terminal device 102, such as, an image processing application, a video conference application, a reading application, a video application, a social application, a payment application, a web browser, an instant messaging tool, and the like, all of which may all be used to present content.

The terminal device 102 here may be hardware or software. When the terminal device 102 is hardware, it may be various electronic devices with a display screen, including but not limited to a smart phone, a tablet, an e-book reader, an MP3 player, a laptop, and a personal computer (PC). When the terminal device 102 is software, it may be installed in the above-listed electronic devices. It may be implemented as multiple software or software modules (for example, to provide distributed services), or may be implemented as a single software or software module. This is not specifically limited here.

The server 104 may be a server that provides various services, for example, a background server that provides support for various applications displayed on the terminal device 102. The database 106 may also be a database that provides various services. It may be understood that when the server 104 can implement the related functions of the database 106, the database 106 may not be provided in the system 100.

The server 104 and the database 106 here may also be hardware or software. When they are hardware, they may be implemented as a distributed server cluster composed of multiple servers, or may be implemented as a single server. When they are software, they may be implemented as multiple software or software modules (for example, to provide distributed services), or may be implemented as a single software or software module. This is not specifically limited here.

It should be noted that the method for interacting based on a virtual object provided in the embodiments of the present disclosure may be performed by the system 100. Specifically, it may be performed by interaction between the terminal device 102, the computer device 103, the server 104, and the database 106. It may be understood that when the terminal device 102 has at least some of the functions of the server 104 and the database 106, it may also be performed by the terminal device 102. It should be understood that the numbers of the terminal device 102, the computer device 103, the user 105, the user 108, the server 104, and the database 106 in FIG. 1A are merely illustrative. According to actual needs, there may be any number of terminal devices, computer devices, users, servers, and databases.

FIG. 1B shows a schematic diagram of an example scenario 110 according to an embodiment of the present disclosure.

As shown in FIG. 1B, in an example scenario 110, the user 108 may trigger an instruction through the terminal device 102, so as to interact with information in a page displayed on the terminal device 102. The terminal device 102 may send a request to be processed to the server 104 in response to the trigger instruction from the user 108. In some embodiments, after receiving the request to be processed, the server 104 may obtain data from the database 106, process the data, then return data to be presented to the terminal device 102. As an optional embodiment, after receiving the request to be processed, the server 104 may directly return data to be presented to the terminal device 102. The terminal device 102 renders the data to be presented, and presents the rendered data to be presented to the user 108 in a form of a page through the terminal device 102.

As described above, the user 108 may obtain and present the delivered information through the terminal device 102. As an example scenario, as shown in FIG. 1B, the terminal device 102 may display a page 112. The target content corresponding to the delivered information obtained by the terminal device 102 may be presented in the page 112 in a form of a video, a picture, or the like.

Product information 114 and a control 116 may also be displayed in the page 112. The product information 114 may include information such as a product name and a product brief introduction. The user 108 may click on the control 116 through the terminal device 102 to trigger an instruction to switch to a page of a platform where the product is located. In some embodiments, the terminal device 102 sends a request to be processed for switching the page to the server 104 in response to the instruction to switch to the page of the platform where the product is located. After receiving the request to be processed, the server 104 may obtain data for processing the request from the database 106 and return data to be presented to the terminal device 102. The terminal device 102 renders and presents the page 122 of the platform where the product is located to the user 108. In some embodiments, words such as “view details” may be displayed on the control 116, so that the user 108 clearly knows the function of triggering the control 116.

The terminal device 102 includes an edge 118, an edge 128, and a bottom 120. In some embodiments, the page 122 may be slid and displayed from one edge of the terminal device 102 to an opposite side. As shown in FIG. 1B, the page 122 may enter from the edge 118 of the terminal device 102 and may be slid and displayed toward the other edge 128 of the terminal device 102 until the page 122 covers a screen of the terminal device 102.

The page 122 may be a page of the platform where the product is located. A picture or a video of the product, product information (for example, information such as a product name and a product price), and the like may be displayed in the page 122. In some embodiments, the page 122 may further include a control 124 and a control 126. The user 108 may click on the control 124 through the terminal device 102 to return to the page 112. The terminal device 102 may return to the page 112 in response to a trigger instruction for the control 124. The control 126 may be used to provide the user 108 with more options, for example, to send a link of the page 122 to another user. In some embodiments, the terminal device 102 may display more options for the user 108 to select in response to a trigger instruction for the control 126.

It can be seen that the user 108 clicks on the control 116 of the page 112 through the terminal device 102 to directly jump to the page 122 of the platform where the product is located. However, in this way, the interaction manner between the user 108 and the target content displayed on the page 112 is relatively simple, and the user 108 cannot perform in-depth interaction with the target content. In addition, the content displayed on the page 112 is also relatively simple, and the difference is not significant, so that the attention of the user cannot be attracted.

In view of this, the present disclosure provides a method and a related device for interacting based on a virtual object. The method comprises: displaying a first page for presenting target content, wherein the first page comprises a first control, and the first control comprises an icon of the virtual object; playing a first animation corresponding to the virtual object in response to a trigger instruction for the first control; and displaying a second page related to the target content in response to the completion of playing of the animation. By playing the animation on the first page, the content displayed on the first page is diversified, thereby increasing the interest of the interaction.

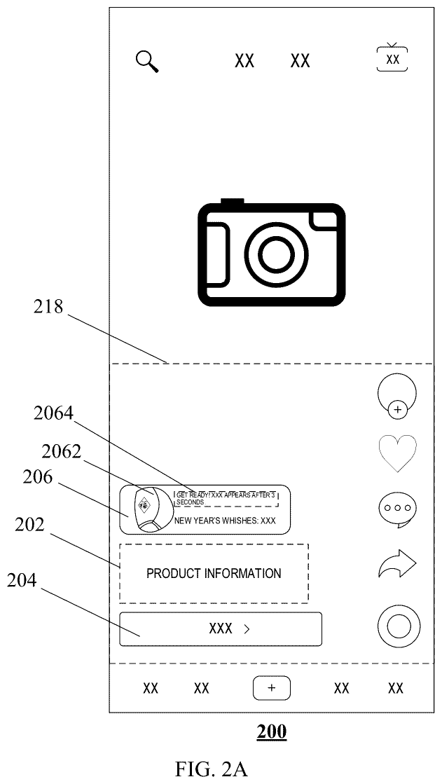

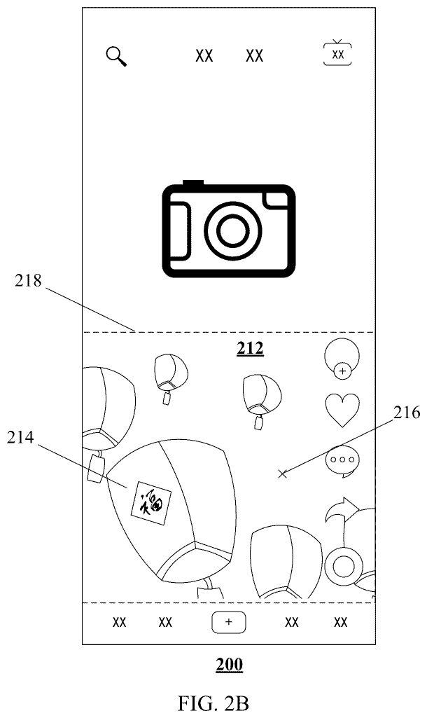

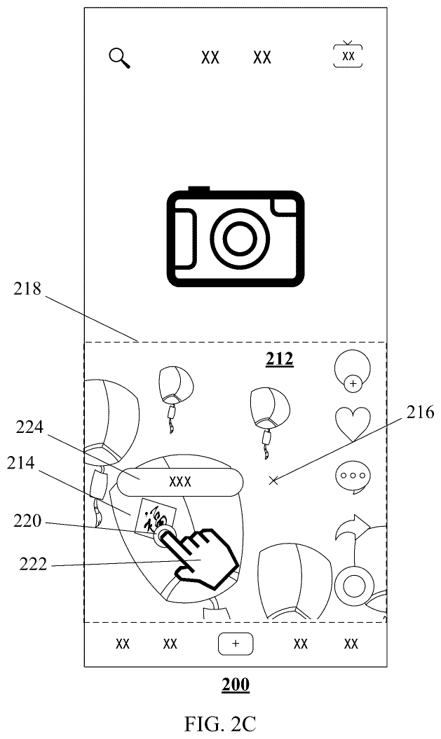

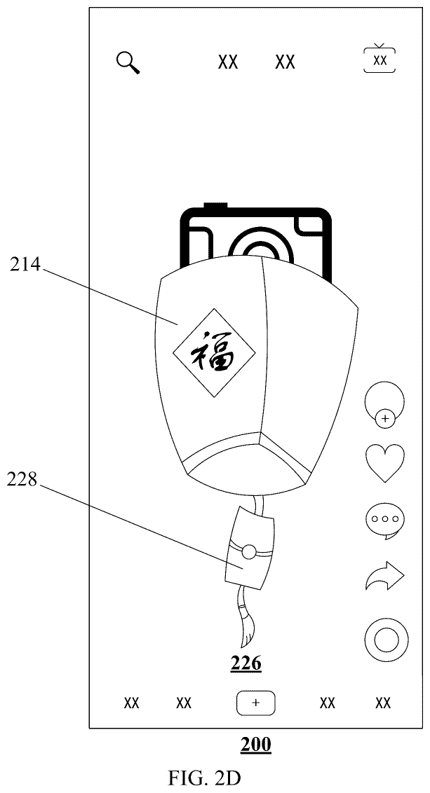

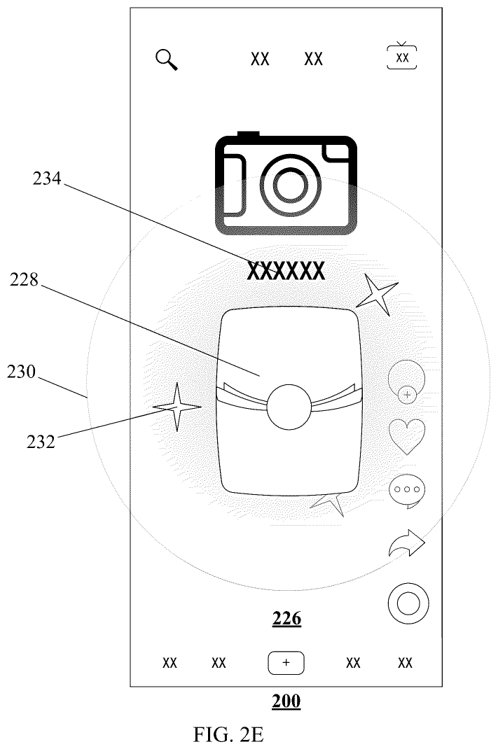

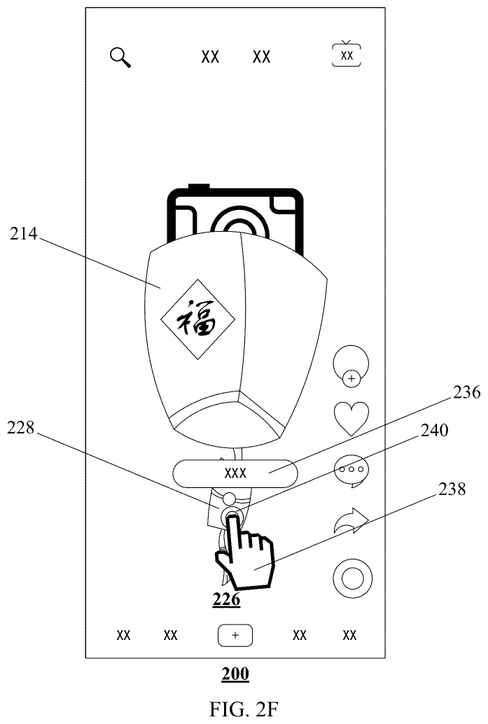

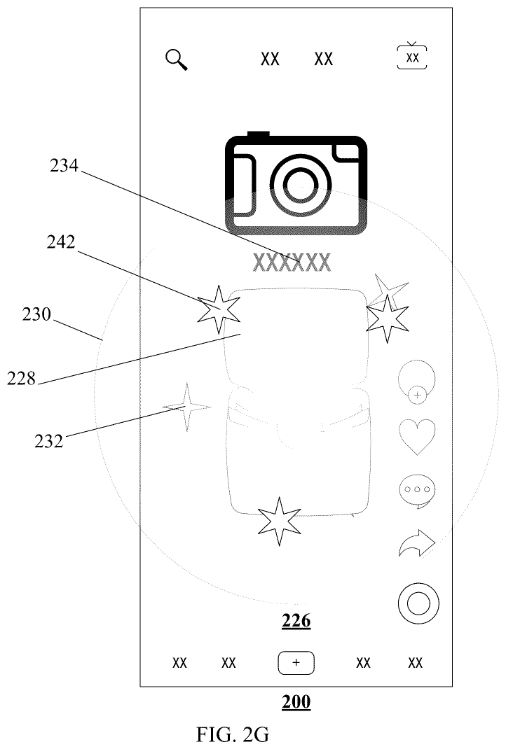

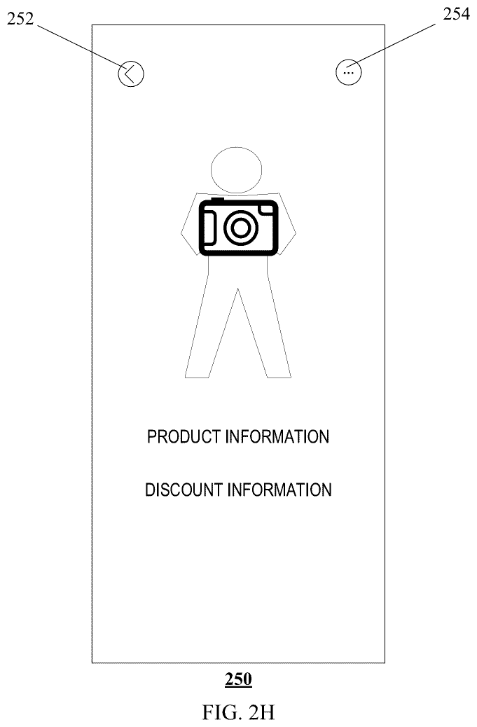

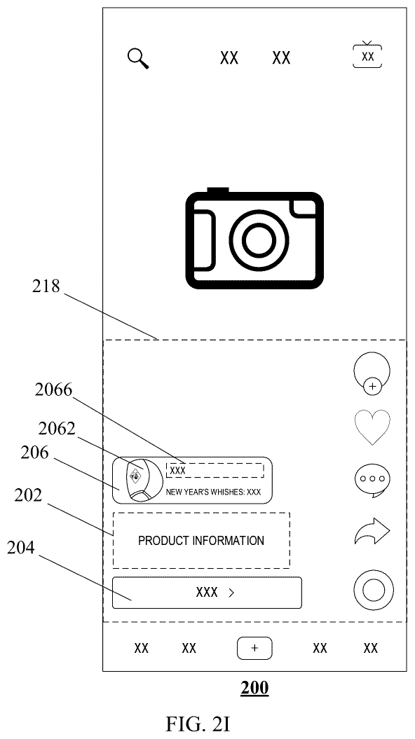

FIG. 2A shows a schematic diagram of an example page 200 according to an embodiment of the present disclosure. The page 200 may be the first page.

As shown in FIG. 2A, the terminal device 102 may display a page 200 for presenting target content in response to a trigger instruction of the user 108. Information 202 (for example, product information) may be displayed in the page 200. The information 202 may comprise information such as a product name and a product brief introduction.

The page 200 may further comprise a control 204 for switching to a page of a platform where the product is located. The terminal device 102 may switch to the page of the platform where the product is located in response to a trigger instruction for the control 204.

In order to make the content displayed on the page 200 more attractive, as shown in FIG. 2A, in some embodiments, the page 200 may further comprise a control 206 (for example, the first control). The control 206 may comprise an icon 2062 of a virtual object. As an optional embodiment, the icon 2062 of the virtual object may be an icon related to a festival element. For Example, the icon 2062 of the virtual object may be a sky lantern related to the Spring Festival, and the word “FU( [symbol] )” may be posted on the sky lantern. The icon 2062 of the virtual object may also be a balloon related to Children's Day, or the like.

In some embodiments, the control 206 may further comprise text content corresponding to the icon 2062 of the virtual object. For example, when the icon 2062 of the virtual object is the sky lantern, the control 206 may display text content such as “New Year's Wishes” for presenting Spring Festival's wishes. In this way, the combination of the icon 2062 of the virtual object and the text content may increase the attention of the user to the control 206 and increase the festival atmosphere.

It may be understood that the display of the icon and the text content related to the festival element by the control 206 is only an example, and the present disclosure is not limited thereto. Other styles of the icon 2062 of the virtual object and the text content that may be displayed by the control 206 also fall within the scope of protection of the present disclosure.

As shown in FIG. 2A, in some embodiments, the control 206 may further comprise a countdown component 2064. When the countdown of the countdown component 2064 expires, it may be considered that the user 108 is interested in the target content displayed on the page 200 or the content played after the control 206 is triggered. Therefore, the terminal device 102 may play an animation corresponding to the icon 2062 of the virtual object in response to the expiration of countdown of the countdown component 2064. Through the setting of the countdown component 2064, on the one hand, the user may have an expectation for the change time, and at the same time, the user's interest in participating in the interaction is enhanced. On the other hand, the countdown of the countdown component 2064 may reflect whether the user stays on the page 200, thereby determining whether the user is interested in the content delivered on the page 200. When the countdown of the countdown component 2064 expires and the user remains on the page 200, it can be determined that the user is interested in the content delivered on the page 200. At this time, the terminal device 102 automatically plays the subsequent animation after the countdown expires, which can better fit the interest points of the user.

As an optional embodiment, the animation corresponding to the icon 2062 of the virtual object may also be manually triggered by the user 108. The user 108 may click on the control 206 through the terminal device 102 to play the animation. The terminal device 102 may play the animation corresponding to the icon 2062 of the virtual object in response to a trigger instruction for the control 206.

FIG. 2B shows a schematic diagram of another example page 200 according to an embodiment of the present disclosure.

When the countdown of the countdown component 2064 expires, as shown in FIG. 2B, an animation 212 (for example, the second animation) may be displayed in the page 200. In some embodiments, the animation 212 may be content corresponding to the icon 2062 of the virtual object. When the user 108 is interested in the virtual object through the icon 2062 displayed by the control 206, the animation 212 corresponding to the virtual object is played to satisfy the user's 108 curiosity about the virtual object presented by the icon 2062.

As shown in FIG. 2B, the page 200 may comprise an area 218 (for example, the target area). In some embodiments, the animation 212 may be displayed in the area 218. Since the area 218 occupies a part of the page 200, the animation 212 displayed in the area 218 does not block the target content displayed in the part of the page 200 not occupied by the area 218. While the animation 212 is displayed, the user can still watch the target content displayed on the page 200.

As shown in FIG. 2A, when the animation 212 is not displayed on the page 200, the control 206, the control 204, and the information 202 (for example, the first information) related to the target content may be displayed in the area 218. The display of the control 206, the control 204, and the information 202 in the area 218 can avoid blocking the target content displayed on the page 200. In order to avoid the animation 212 displayed in the same area 218 overlapping with the control 206, the control 204, and the information 202 related to the target content after being displayed, in some embodiments, as shown in FIG. 2B, the animation 212 may be displayed after the control 206, the control 204, and the information 202 related to the target content are hidden when the countdown of the countdown component 2064 expires. In this way, the problem is avoided that the user's perception and information acquisition are affected since the display of a plurality of different contents in the area 218 at the same time may cause the contents to overlap.

The manner of hiding the control 206, the control 204, and the information 202 related to the target content and the manner of displaying the animation 212 may correspond to a virtual object 214 played in the animation 212. Taking the virtual object 214 played in the animation 212 being a sky lantern as an example, in some embodiments, the animation 212 may be displayed in the area 218 in a manner of rising upward from the bottom 120 of the terminal device 102. The manner of rising upward imitates the release manner of the sky lantern in actual use, so that the display effect of the animation 212 on the page 200 is more realistic, thereby making the user's perception better.

Corresponding to the animation 212 displayed in the area 218 in the manner of rising upward, in some embodiments, the control 206, the control 204, and the information 202 related to the target content may be hidden in a manner of retracting downward from the bottom of the terminal device 102. In this way, the retracting in the direction opposite to the rising of the animation 212 can make the connection between the control 206, the control 204, the information 202, and the animation 212 more coherent, thereby making the user's perception better.

It may be understood that the above is only an example description of the virtual object 214 in the animation 212 as the sky lantern, but the present disclosure is not limited thereto. A display manner of the animation 212 adapted to the style when the virtual object 214 is in another style and a hiding manner of the control 206, the control 204, and the information 202 also fall within the scope of protection of the present disclosure.

FIG. 2C shows a schematic diagram of another example page 200 according to an embodiment of the present disclosure.

As shown in FIG. 2C, the animation 212 may comprise a control 220 (for example, the second control) corresponding to the virtual object 214. In some embodiments, the user 108 may click on the control 220 through the terminal device 102 to trigger an instruction to continue playing the animation or to play another animation. The terminal device 102 may play the animation corresponding to the virtual object 214 in response to a trigger instruction for the control 220. Through the virtual object 214 in the animation 212, the mystery of the virtual object 214 can attract the user to click on the control 220 through the terminal device 102 while increasing the interest of the user in interacting with the target content.

As shown in FIG. 2C, the animation 212 comprises a plurality of virtual objects 214. The control 220 corresponds to a target virtual object (for example, a virtual object that needs to be clicked by the user through the terminal device) in the plurality of virtual objects 214. In some embodiments, an icon 222 for indicating a position of the control 220 and prompt information 224 may also be displayed in the animation 212. For example, the icon 222 may be a gesture of an index finger clicking, and the position of the index finger may be the position of the control 220. The prompt information 224 may be used to indicate the position of the control 220 and prompt the user that the control 220 may be clicked through the terminal device. The setting of the icon 222 and the prompt information 224 may further attract the attention of the user, so that the user triggers an instruction to display a subsequent animation through the control 220.

As shown in FIG. 2C, the page 200 may be a portrait page. In some embodiments, the area 218 may be located at a lower part of the portrait page 200. The location of the area 218 at the lower part of the portrait page 200 is more in line with the user's habit of single-hand operation. When the user operates the terminal device 102 with one hand, the area 218 and the animation 212 at the lower part of the portrait page 200 may facilitate the user to click on the control 220. In this way, the operation of the user is facilitated.

The terminal device 102 may further play a subsequent animation in response to a trigger instruction for the control 220.

FIG. 2D shows a schematic diagram of another example page 200 according to an embodiment of the present disclosure.

As shown in FIG. 2D, after the user 108 clicks on the control 220 through the terminal device 102, an animation 226 (for example, the first animation) may be further displayed in the page 200. Since the animation 226 is triggered by the user 108 actively clicking on the control 220, it can be determined that the user 108 is interested in the virtual object 214. Therefore, in some embodiments, the terminal device 102 may display the animation 226 in response to a trigger instruction for the control 220. In the animation 226, other virtual objects in the animation 212 may be hidden, and the virtual object 214 may be displayed at the middle position of the page 200. In some embodiments, the virtual object 214 may include content 228 (for example, a coupon) related to resource acquisition. In order to increase the interest of the user 108 in acquiring resources, a display style of the content 228 related to resource acquisition may match the style of the virtual object 214. For example, when the style of the virtual object 214 is the sky lantern, the content 228 related to resource acquisition may be displayed on the page 200 in a form of being hung on the virtual object 214 (for example, in a form of a red envelope hung on the sky lantern). In this way, the playing of the animation 226 increases the interest of the user in acquiring resources.

As an optional embodiment, the user 108 may also drag the virtual object 214 upward in the area 212 through an operation of dragging the virtual object 214 to move out of the area 212 and to the middle position of the page 200. The terminal device 102 may hide other virtual objects in the area 212 and display the virtual object 214 at the middle position of the page 200 in response to the dragging operation for the virtual object 214. In the process of dragging the virtual object 214 upward by the user 108, the content 228 related to resource acquisition on the virtual object 214 will also be gradually displayed on the page 200 with the movement of the virtual object 214. Such a process can further surprise the user.

FIG. 2E shows a schematic diagram of another example page 200 according to an embodiment of the present disclosure.

As shown in FIG. 2E, in order to further allow the user to have an expectation for the change time, and at the same time, enhance the user's interest in participating in the interaction, in some embodiments, after the virtual object 214 with the content 228 related to resource acquisition being displayed at the middle position of the page 200, the virtual object 214 may be hidden, and the content 228 related to resource acquisition may be further displayed at the middle position of the page 200. Therefore, the attention of the user 108 is focused on the content 228 related to resource acquisition.

FIG. 2F shows a schematic diagram of another example page 200 according to an embodiment of the present disclosure.

The display of the content 228 related to resource acquisition may be displayed through the automatic playing of the animation 226. As an optional embodiment, the content 228 related to resource acquisition may be displayed at the middle position of the page 200 through a trigger instruction from the user 108. As shown in FIG. 2F, the animation 226 may comprise a control 240. The terminal device 102 may hide the virtual object 214 and display the content 228 related to resource acquisition at the middle position of the page 200 in response to a trigger instruction for the control 240. The animation 226 may further comprise an icon 238 for indicating a position of the control 240 and prompt information 236. For example, the icon 238 may be a gesture of an index finger clicking, and the position of the index finger may be the position of the control 240. The prompt information 236 may be used to indicate the position of the control 240 and prompt the user that the control 240 may be clicked through the terminal device. Triggering the further display of the content 228 related to resource acquisition by attracting the user to actively click on the control can increase the interest of the interaction between the user and the animation 226. The setting of the icon 238 and the prompt information 236 may further attract the attention of the user, so that the user triggers an instruction to display a subsequent animation through the control 240.

Returning to FIG. 2E, in order to highlight the content 228 related to resource acquisition, in some embodiments, a shining halo 230 and starlight 232 may be displayed around the content 228 related to resource acquisition, so that the content 228 related to resource acquisition has a glittering display effect to increase the expectation of the user 108 for the resource to be acquired.

As shown in FIG. 2E, in some embodiments, the animation 226 may further comprise text content 234. The text content 234 may display festival-related wishes and the like, so as to heighten the atmosphere through the text content 234 while sending the content 228 related to resource acquisition to the user 108.

For example, the text content 234 may display “You have worked hard this year. Please accept this gift!”. In this way, through the expression of the text content 234, an emotional link can be established between the user 108 and the target content in the page 200.

It may be understood that the above is only an example description of the text content 234 that may display “You have worked hard this year. Please accept this gift!”, but the present disclosure is not limited thereto. Other content displayed by the text content 234 also falls within the scope of protection of the present disclosure.

After the content 228 related to resource acquisition is displayed at the middle position of the page 200, the animation 226 may further display subsequent content.

FIG. 2G shows a schematic diagram of another example page 200 according to an embodiment of the present disclosure.

As shown in FIG. 2G, the animation 226 may further display an animation of a process of unfolding the content 228 related to resource acquisition. For example, when the content 228 related to resource acquisition is a red envelope, the subsequent animation 226 may display a process of opening the red envelope. In some embodiments, in the process of unfolding the content 228 related to resource acquisition, more shining starlight 242 may be displayed in the animation 226, so that the process of acquiring the resource is more touching and attractive.

FIG. 2H shows a schematic diagram of an example page 250 according to an embodiment of the present disclosure.

As shown in FIG. 2H, in some embodiments, after the completion of animation 226, the terminal device 102 may display a page 250 (for example, the second page) related to the target content in the page 200. For example, when the target content is related to the product, after the animation 226 is completed, the terminal device 102 may jump to a page of a platform where the product is located.

In some embodiments, the page 250 may be slid and displayed from one edge of the terminal device 102 to an opposite side. For example, as shown in FIG. 1B, the page 250 may enter from the edge 118 of the terminal device 102 and be slid and displayed toward the other edge 128 of the terminal device 102, until the page 250 covers the screen of the terminal device 102.

A picture and information (for example, product information) related to the target content and information (for example, discount information) related to the content 228 may be displayed in the page 250. In this way, after the competition of playing of the animation 226, the user 108 can directly see the specific content of the content 228 related to resource acquisition on the page 250. When the page 250 is a page of the platform where the product is located, after acquiring the resource, the user 108 may directly use the resource on the page 250, which can improve the usage rate of the resource.

As shown in FIG. 2H, in some embodiments, the page 250 may further comprise a control 252 and a control 254. The user 108 may click on the control 252 through the terminal device 102 to return to the page 200. The terminal device 102 may return to the page 200 in response to a trigger instruction for the control 252. The control 254 may be used to provide the user 108 with more options, for example, to send a link of the page 254 to another user. The terminal device 102 may display an option of sharing the link in response to a trigger instruction for the control 254.

In order to avoid a relatively stiff and fragmented visual effect of page switching between the page 200 and the page 250, in some embodiments, as shown in FIG. 2G, a transition animation may be played at the end of the animation 226. For example, when the content 228 related to resource acquisition is a red envelope, the transition animation may be light in the shining halo 230 concentrating on the middle of the red envelope (for example, a position where the red envelope is opened), so that the process of opening the red envelope is more attractive. The display of the transition animation makes the switching between the page 200 and the page 250 more vivid. At the same time, the light concentrated in the middle of the red envelope attracts the attention of the user 108 and distracts the attention of the user 108 from the process of switching from the page 200 to the page 250, thereby weakening the sense of fragmentation of the user 108 from the page 200 to the page 250.

Returning to FIG. 2B, in some embodiments, a control 216 (for example, the third control) for closing the animation 212 is displayed in the animation 212. After the animation 212 is displayed, if the user is not interested in the animation 212, the user may click on the control 216 through the terminal device 102 to close the animation 212. The terminal device 102 may close the animation 212 and display the control 206, the control 204, and the information 202 related to the target content in response to a trigger instruction for the control 216. The setting of the control 216 may provide the user 108 with higher freedom of choice.

The manner of displaying the control 206, the control 204, and the information 202 related to the target content and the manner of hiding the animation 212 after the animation 212 is closed may be opposite to the above manner of hiding the control 206, the control 204, and the information 202 related to the target content and the manner of displaying the animation 212. In some embodiments, the animation 212 may be closed in a manner of retracting downward from the bottom 120 of the terminal device 102. The control 206, the control 204, and the information 202 related to the target content may be displayed in a manner of rising upward from the bottom 120 of the terminal device 102. The display and retracting manner of one up and one down makes the closing of the animation 212 and the display process of the control 206, the control 204, and the information 202 related to the target content more coherent.

FIG. 2I shows a schematic diagram of another example page 200 according to an embodiment of the present disclosure.

If the user 108 clicks on the control 216 through the terminal device 102 to close the animation 212, it can be determined that the user 108 is not interested in the animation 212. At this time, the countdown component 2064 in the control 206 may be hidden, and the text content 2066 may be displayed. After closing the second animation, the user can continue to watch the target content presented on the page 200. In some embodiments, the terminal device 102 may close the animation 212 and display the control 206, the control 204, and the information 202 related to the target content in response to a trigger instruction for the control 216. The terminal device 102 may hide the countdown component 2064 in the control 206 and display the text content 2066. In some embodiments, the text content 2066 may be used to prompt the user 108 to click on the control 206 to display the animation 212 again. For example, the text content 2066 may display content such as “Come and receive!” to attract the user 108 to trigger the control 206 again.

After the user 108 clicks on the control 206 through the terminal device 102, the terminal device 102 may display the animation 212 again. In some embodiments, the terminal device 102 may play the animation 212 corresponding to the virtual object 214 in response to a trigger instruction for the control 206. The user 108 may click on the control 220 in the animation 212 through the terminal device 102 to display the animation 226 to acquire resources. As an optional embodiment, the terminal device 102 may play the animation 226 corresponding to the virtual object 214 in response to a trigger instruction for the control 206. In this way, the user 108 can acquire resources by clicking on the control 206 once, instead of clicking on the control multiple times, thereby avoiding the problem of cumbersome operation caused by the user needing to click on the control multiple times.

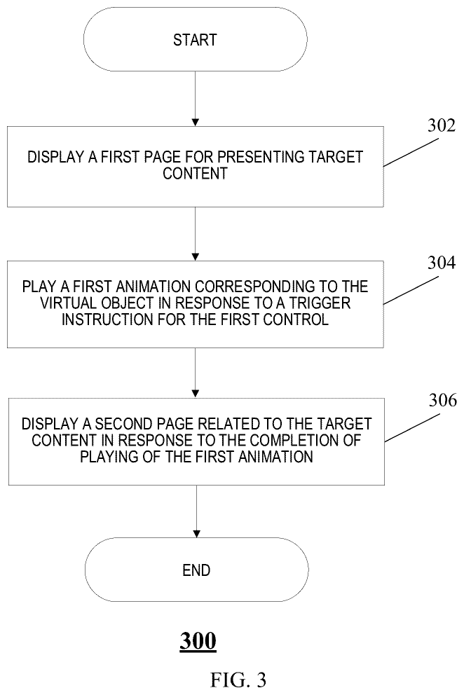

FIG. 3 shows a schematic flowchart of an example method 300 for interacting based on a virtual object according to an embodiment of the present disclosure. The method 300 may be implemented by the system 100 (for example, the system 100 in FIG. 1A). For example, the user 108 (for example, the user 108 in FIG. 1A) may click on a control in a page through the terminal device 102 (for example, the terminal device 102 in FIG. 1A) to trigger an instruction. The terminal device 102 sends a corresponding request to the server 104 (for example, the server 104 in FIG. 1A) in response to the trigger instruction. The server 104 may obtain corresponding data from the database 106 (for example, the database 106 in FIG. 1A) according to the request. Then, the server 104 may process the request according to the data and return a processing result (for example, data to be presented) to the terminal device 102, so that the processing result is presented to the user 108 in a form of a page or another form after being rendered by the terminal device 102. The method 300 may comprise the following steps.

In step 302, a first page (for example, the page 200 in FIG. 2A) for presenting target content is displayed, where the first page comprises a first control (for example, the control 206 in FIG. 2A), and the first control comprises an icon of the virtual object (for example, the icon 2062 of the virtual object in FIG. 2A).

In some embodiments, the first control further comprises a countdown component (for example, the countdown component 2064 in FIG. 2B), and playing the first animation (for example, the animation 226 in FIG. 2D) corresponding to the virtual object (for example, the virtual object 214 in FIG. 2D) in response to a trigger instruction for the first control comprises: playing the first animation corresponding to the virtual object in response to the expiration of countdown of the countdown component. Through the setting of the countdown component, on the one hand, the user can have an expectation for the change time, and at the same time, the user's interest in participating in the interaction is enhanced. On the other hand, the countdown of the countdown component may reflect whether the user stays on the first page, thereby determining whether the user is interested in the content delivered on the first page. When the countdown of the countdown component expires and the user remains on the first page, it can be determined that the user is interested in the content delivered on the first page. At this time, the terminal device automatically plays the subsequent animation after the countdown expires, which can better fit the interest points of the user.

In some embodiments, displaying the first page for presenting the target content comprises: displaying the first control and first information (for example, the information 202 in FIG. 2A) related to the target content in the target area (for example, the area 218 in FIG. 2B). The first information may comprise information such as a product name and a product brief introduction. The display of the first control and the first information in the target area can avoid blocking the target content displayed on the first page.

In some embodiments, displaying the second animation (for example, the animation 212 in FIG. 2B) in the first page in response to the expiration of countdown of the countdown component comprises: in response to the expiration of countdown of the countdown component, hiding the first information and the first control, and displaying the second animation in the target area. In this way, the problem is avoided that the user's perception and information acquisition are affected since display of a plurality of different contents in the area at the same time may cause the contents to overlap.

In some embodiments, displaying the second animation in the target area comprises: rising the second animation upward from a bottom (for example, the bottom 120 in FIG. 1B) of the first page. The manner of rising upward imitates the release manner of the virtual object in actual use, so that the display effect of the second animation on the first page is more realistic, thereby making the user's perception better.

In some embodiments, hiding the first information and the first control comprises: retracting the first information and the first control downward from a bottom of the first page. In this way, the retracting in the direction opposite to the rising of the second animation may make the connection of the switching between the first information and the first control and the second animation more coherent, thereby making the user's perception better.

In some embodiments, displaying the second animation in the first page further comprises: displaying a third control (for example, the control 216 in FIG. 2B) for closing the second animation in the second animation. The setting of the third control can provide the user with higher freedom of choice.

In some embodiments, the method further comprises: closing the second animation and displaying the first information and the first control in response to a trigger instruction for the third control. After closing the second animation, the user can continue to watch the target content presented on the first page.

In step 304, a first animation corresponding to the virtual object is played in response to a trigger instruction for the first control.

In some embodiments, playing the first animation corresponding to the virtual object in response to the expiration of countdown of the countdown component comprises: displaying a second animation in the first page in response to the expiration of countdown of the countdown component, where the second animation comprises a second control (for example, the control 220 in FIG. 2C) corresponding to the virtual object; and playing the first animation corresponding to the virtual object in response to a trigger instruction for the second control. Through the virtual object in the second animation, the mystery of the virtual object can attract the user to click on the second control through the terminal device while increasing the interest of the user in interacting with the target content.

In some embodiments, displaying the second animation in the first page comprises: displaying the second animation in a target area of the first page, where the target area occupies a part of the first page. The second animation displayed in the target area does not block the target content displayed in the part of the first page not occupied by the target area. While the second animation is displayed, the user can still watch the target content displayed on the first page.

In some embodiments, the first page is a portrait page, and the second animation is located at a lower part of the first page. When the user operates the terminal device with one hand, the target area and the second animation at the lower part of the vertical page can facilitate the user to click on the second control. In this way, the operation of the user is facilitated.

In some embodiments, the second animation comprises a plurality of the virtual objects, the second control corresponds to a target virtual object in the plurality of virtual objects, and displaying the second animation in the first page further includes: displaying, in the second animation, prompt information (for example, the prompt information 224 or the icon 222 in FIG. 2C) for indicating a position of the second control. The setting of the prompt information can further attract the attention of the user, so that the user triggers an instruction to display a subsequent animation through the second control.

In some embodiments, an end of the first animation comprises a transition animation. The display of the transition animation makes the switching of the page more vivid and weakens the sense of fragmentation of the page switching.

In step 306, a second page (for example, the page 250 in FIG. 2H) related to the target content is displayed in response to the completion of playing of the first animation.

In some embodiments, the first animation comprises content related to resource acquisition, and the second page is related to the acquired resource. After acquiring the resource, the user may directly use the resource on the second page, which can improve the usage rate of the resource.

The present disclosure provides a method and a related device for interacting based on a virtual object. The method comprises: displaying a first page for presenting target content, where the first page comprises a first control, and the first control comprises an icon of the virtual object; playing a first animation corresponding to the virtual object in response to a trigger instruction for the first control; and displaying a second page related to the target content in response to the completion of playing of the first animation. The display of the content on the first page is diversified in a manner of playing the animation on the first page, and the interest of interaction is increased.

It should be noted that the method of the embodiments of the present disclosure may be performed by a single device, for example, a computer or a server. The method of this embodiment may also be applied to distributed scenarios, and is completed by a plurality of devices cooperating with each other. In such a distributed scenario, one of the plurality of devices may only perform one or more steps of the method of the embodiments of the present disclosure, and the plurality of devices will interact with each other to complete the method.

It should be noted that some embodiments of the present disclosure have been described above. Other embodiments are within the scope of the appended claims. In some cases, actions or steps recited in the claims may be performed in an order different from that in the above embodiments and still achieve the desired results. In addition, the processes depicted in the accompanying drawings do not necessarily require the specific order or sequential order shown to achieve the desired results. In some implementations, multitasking and parallel processing are also possible or may be advantageous.

Based on the same technical concept, corresponding to the method of any of the above embodiments, the present disclosure also provides an apparatus 400 for interacting based on a virtual object.

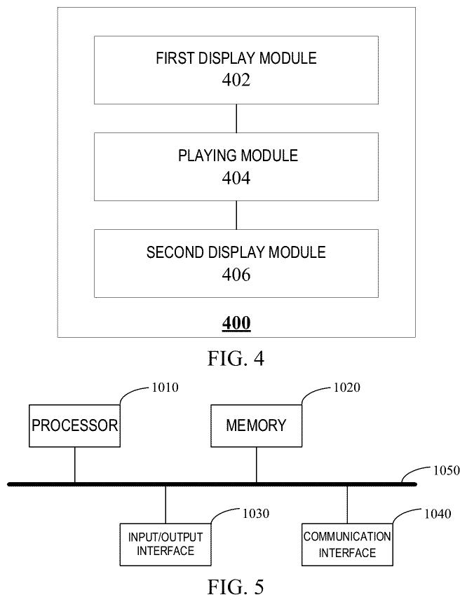

Referring to FIG. 4, the apparatus 400 comprises:
a first display module 402, configured to display a first page for presenting target content, where the first page comprises a first control, and the first control comprises an icon of the virtual object.

In some embodiments, the first display module 402 is further configured to play a first animation corresponding to the virtual object in response to the expiration of countdown of a countdown component.

In some embodiments, the first display module 402 is further configured to display the first control and first information related to the target content in a target area.

In some embodiments, the first display module 402 is further configured to hide the first information and the first control and display a second animation in the target area in response to the expiration of countdown of the countdown component.

In some embodiments, the first display module 402 is further configured to retract the first information and the first control downward from a bottom of the first page.

In some embodiments, the first display module 402 is further configured to rise the second animation upward from the bottom of the first page.

In some embodiments, the first display module 402 is further configured to display a third control for closing the second animation in the second animation.

In some embodiments, the apparatus 400 further comprises a closing module, and the closing module is configured to close the second animation and display the first information and the first control in response to a trigger instruction for the third control.

A playing module 404 is configured to play a first animation corresponding to the virtual object in response to a trigger instruction for the first control.

In some embodiments, the playing module 404 is further configured to display a second animation in the first page in response to the expiration of countdown of the countdown component, where the second animation includes a second control corresponding to the virtual object; and play the first animation corresponding to the virtual object in response to a trigger instruction for the second control.

In some embodiments, the playing module 404 is further configured to display the second animation in a target area of the first page, where the target area occupies a part of the first page.

In some embodiments, the first page is a portrait page, and the second animation is located at a lower part of the first page.

In some embodiments, the second animation includes a plurality of the virtual objects, the second control corresponds to a target virtual object in the plurality of virtual objects, and the playing module 404 is further configured to display, in the second animation, prompt information for indicating a position of the second control.

In some embodiments, an end of the first animation includes a transition animation.

A second display module 406 is configured to display a second page related to the target content in response to the completion of playing of the first animation.

In some embodiments, the first animation includes content related to resource acquisition, and the second page is related to the acquired resource.

For the convenience of description, when describing the above apparatus, the functions are divided into various modules for description respectively. Of course, when implementing the present disclosure, the functions of the modules may be implemented in the one or a plurality of software and/or hardware.

The apparatus in the above embodiment is configured to implement the corresponding method 300 in any of the foregoing embodiments, and has the beneficial effects of the corresponding method embodiment, which will not be repeated here.

Based on the same technical concept, corresponding to the method of any of the above embodiments, the present disclosure further provides an electronic device, including a memory, a processor, and a computer program stored in the memory and executable on the processor, where the processor, when executing the program, implements the method 300 described in any of the above embodiments.

FIG. 5 shows a schematic diagram of an example electronic device according to an embodiment of the present disclosure. The device may comprise: a processor 1010, a memory 1020, an input/output interface 1030, a communication interface 1040, and a bus 1050. The processor 1010, the memory 1020, the input/output interface 1030, and the communication interface 1040 implement communication connection with each other inside the device through the bus 1050.

The processor 1010 may be implemented by a general-purpose CPU (Central Processing Unit), a microprocessor, an ASIC (Application Specific Integrated Circuit), or one or more integrated circuits, and is configured to execute related programs to implement the technical solutions provided in the embodiments of the present specification.

The memory 1020 may be implemented in the form of a ROM (Read Only Memory), a RAM (Random Access Memory), a static storage device, a dynamic storage device, or the like. The memory 1020 may store an operating system and other applications. When the technical solutions provided in the embodiments of the present specification are implemented by software or firmware, the related program code is stored in the memory 1020 and is called and executed by the processor 1010.

The input/output interface 1030 is configured to connect an input/output module to implement information input and output. The input/output module may be configured as a component in the device (not shown in the figure), or may be externally connected to the device to provide corresponding functions. The input device may include a keyboard, a mouse, a touch screen, a microphone, various sensors, and the like, and the output device may include a display, a speaker, a vibrator, an indicator light, and the like.

The communication interface 1040 is configured to connect a communication module (not shown in the figure) to implement communication interaction between the device and other devices. The communication module may implement communication in a wired manner (for example, USB, network cable, etc.) or in a wireless manner (for example, mobile network, WIFI, Bluetooth, etc.).

The bus 1050 includes a path for transmitting information between various components (for example, the processor 1010, the memory 1020, the input/output interface 1030, and the communication interface 1040) of the device.

It should be noted that although the above device shows only the processor 1010, the memory 1020, the input/output interface 1030, the communication interface 1040, and the bus 1050, in a specific implementation process, the device may further include other components necessary for normal operation. In addition, those skilled in the art may understand that the above device may also include only components necessary for implementing the solutions of the embodiments of the present specification, rather than all components shown in the figure.

The electronic device in the above embodiment is configured to implement the corresponding method 300 in any of the foregoing embodiments, and has the beneficial effects of the corresponding method embodiment, which will not be repeated here.

Based on the same technical concept, corresponding to the method of any of the above embodiments, the present disclosure further provides a non-transitory computer-readable storage medium storing computer instructions, where the computer instructions are used to cause the computer to execute the method 300 described in any of the above embodiments.

The computer-readable medium in this embodiment includes persistent and non-persistent, removable and non-removable media, which can implement information storage by any method or technology. The information may be computer-readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory, or other memory technologies, read-only compact discs (CD-ROM), digital versatile discs (DVD) or other optical storage, magnetic cassette, magnetic tape magnetic disk storage, or other magnetic storage devices, or any other non-transmission medium, which can be used to store information accessible by a computing device.

The computer instructions stored in the storage medium in the above embodiments are configured to cause the computer to execute the method 300 described in any of the above embodiments, and have the beneficial effects of the corresponding method embodiment, which will not be repeated here.

Based on the same inventive concept, corresponding to the method 300 described in any of the above embodiments, the present application further provides a computer program product, including computer program instructions that, when running on a computer, cause the computer to execute the method 300 described in any of the above embodiments. In some embodiments, the computer program instructions may be executed by one or more processors of the computer to cause the computer and/or the processor to execute the method 300. A processor that executes a corresponding step corresponds to an execution subject corresponding to each step in each embodiment of the method 300.

The computer program product in the above embodiment is configured to cause the computer and/or the processor to execute the method 300 described in any of the above embodiments, and has the beneficial effects of the corresponding method embodiment, which will not be repeated here.

Those of ordinary skill in the art should understand that the discussions of any of the above embodiments are example only, and are not intended to imply that the scope of the present disclosure (including the claims) is limited to these examples; under the idea of the present disclosure, the technical features in above embodiments or different embodiments may also be combined, and the steps may be implemented in any order, and there are many other variations of different aspects of the embodiments of the present disclosure as described above. For the sake of brevity, they are not provided in detail.

In addition, in order to simplify the description and discussion, and in order not to make the embodiments of the present disclosure difficult to understand, well-known power supply/ground connections to integrated circuit (IC) chips and other components may or may not be shown in the provided figures. Further, the apparatus may be shown in block diagram form in order to avoid making the embodiments of the present disclosure difficult to understand, and this is also taken into account the fact that the details of the implementation of these block diagram apparatuses are highly dependent on the platform on which the embodiments of the present disclosure will be implemented (that is, these details should be completely within the understanding of those skilled in the art). In the case where specific details (for example, circuits) are set forth in order to describe the example embodiments of the present disclosure, it will be apparent to those skilled in the art that the embodiments of the present disclosure may be implemented without these specific details or with variations of these specific details. Therefore, these descriptions should be considered as illustrative rather than restrictive.

Although the present disclosure has been described in conjunction with specific embodiments of the present disclosure, many alternatives, modifications, and variations of these embodiments will be apparent to those of ordinary skill in the art from the foregoing description. For example, other memory architectures (e.g., dynamic RAM (DRAM)) may use the embodiments discussed.

The embodiments of the present disclosure are intended to cover all such alternatives, modifications, and variations as fall within the broad scope of the appended claims. Therefore, any omission, modification, equivalent replacement, improvement, etc. made within the spirit and principle of the embodiments of the present disclosure shall be included within the scope of protection of the present disclosure.

I/We claim:

1. A method for interacting based on a virtual object, comprising:
displaying a first page for presenting target content, wherein the first page comprises a first control, and the first control comprises an icon of the virtual object;
playing a first animation corresponding to the virtual object in response to a trigger instruction for the first control; and
displaying a second page related to the target content in response to a completion of playing of the first animation.

2. The method according to claim 1, wherein the first control further comprises a countdown component, and playing the first animation corresponding to the virtual object in response to the trigger instruction for the first control comprises:
playing the first animation corresponding to the virtual object in response to an expiration of countdown of the countdown component.

3. The method according to claim 2, wherein playing the first animation corresponding to the virtual object in response to the expiration of countdown of the countdown component comprises:
displaying a second animation in the first page in response to the expiration of countdown of the countdown component, wherein the second animation comprises a second control corresponding to the virtual object; and
playing the first animation corresponding to the virtual object in response to a trigger instruction for the second control.

4. The method according to claim 3, wherein displaying the second animation in the first page comprises:
displaying the second animation in a target area of the first page, wherein the target area occupies a part of the first page.

5. The method according to claim 4, wherein the first page is a portrait page, and the second animation is located at a lower part of the first page.

6. The method according to claim 3, wherein the second animation comprises a plurality of virtual objects, the second control corresponds to a target virtual object in the plurality of virtual objects, and displaying the second animation in the first page further comprises:
displaying, in the second animation, prompt information for indicating a position of the second control.

7. The method according to claim 4, wherein displaying the first page for presenting the target content comprises:
displaying the first control and first information related to the target content in the target area.

8. The method according to claim 7, wherein displaying the second animation in the first page in response to the expiration of countdown of the countdown component comprises:
in response to the expiration of countdown of the countdown component, hiding the first information and the first control, and displaying the second animation in the target area.

9. The method according to claim 8, wherein hiding the first information and the first control comprises:
retracting the first information and the first control downward from a bottom of the first page.

10. The method according to claim 8, wherein displaying the second animation in the target area comprises:
rising the second animation upward from a bottom of the first page.

11. The method according to claim 8, wherein displaying the second animation in the first page further comprises:
displaying a third control for closing the second animation in the second animation.

12. The method according to claim 11, wherein the method further comprises:
in response to a trigger instruction for the third control, closing the second animation and displaying the first information and the first control.

13. The method according to claim 1, wherein the first animation comprises content related to resource acquisition, and the second page is related to an acquired resource.

14. The method according to claim 1, wherein an end of the first animation comprises a transition animation.

15. An electronic device, comprising a memory, a processor, and a computer program stored in the memory and executable on the processor, wherein the processor, when executing the program, implements acts comprising:
displaying a first page for presenting target content, wherein the first page comprises a first control, and the first control comprises an icon of a virtual object;
playing a first animation corresponding to the virtual object in response to a trigger instruction for the first control; and
displaying a second page related to the target content in response to a completion of playing of the first animation.

16. The electronic device according to claim 15, wherein the first control further comprises a countdown component, and playing the first animation corresponding to the virtual object in response to the trigger instruction for the first control comprises:
playing the first animation corresponding to the virtual object in response to an expiration of countdown of the countdown component.

17. The electronic device according to claim 16, wherein playing the first animation corresponding to the virtual object in response to the expiration of countdown of the countdown component comprises:
displaying a second animation in the first page in response to the expiration of countdown of the countdown component, wherein the second animation comprises a second control corresponding to the virtual object; and
playing the first animation corresponding to the virtual object in response to a trigger instruction for the second control.

18. The electronic device according to claim 17, wherein displaying the second animation in the first page comprises:
displaying the second animation in a target area of the first page, wherein the target area occupies a part of the first page.

19. The electronic device according to claim 18, wherein the first page is a portrait page, and the second animation is located at a lower part of the first page.

20. A non-transitory computer-readable storage medium storing computer instructions, wherein the computer instructions are configured to cause a computer to perform a method comprising:
displaying a first page for presenting target content, wherein the first page comprises a first control, and the first control comprises an icon of a virtual object;
playing a first animation corresponding to the virtual object in response to a trigger instruction for the first control; and
displaying a second page related to the target content in response to a completion of playing of the first animation.
